(19) United States
(12) Patent Application Publication
(10) Pub. No.: US 2015/0336848 A1
(43) Pub. Date: Nov. 26, 2015

(54) CEMENT GRINDING AID COMPOSITION

(71) Applicant: Dow Global Technologies LLC, Midland, MI (US)

(72) Inventors: Ritesh Gulabani, Vadodara (IN); Prashant Tatake, Mumbai (IN)

(73) Assignee: Dow Global Technologies LLC, Midland, MI (US)

(21) Appl. No.: 14/410,316

(22) PCT Filed: May 31, 2013
(86) PCT No.: PCT/US2013/043571

§ 371 Date: Dec. 22, 2014

(30) Foreign Application Priority Data
Jun. 25, 2012 (IN) 2504/CHE/2012

(51) Int. Cl. C04B 24/12; C04B 7/04

(52) U.S. Cl. CPC C04B 24/122; C04B 7/04

(57) ABSTRACT

A grinding aid composition for improving the efficiency of cement grinding. The grinding aid composition comprises: an alkanolamine compound that is a primary alkanolamine compound, a secondary alkanolamine compound, or a mixture thereof; and a glycol.

### CROSS-REFERENCE TO RELATED APPLICATIONS

This application claims priority from provisional application Ser. No. 2504/CHE/2012, filed Jun. 25, 2012, which is incorporated herein by reference in its entirety.

### FIELD

This invention relates generally to a grinding aid composition for use in the manufacture of cement.

### BACKGROUND

Cements are generally manufactured through calcination of raw materials to produce a sintered “clinker.” Gypsum is then mixed with the clinker at small amounts and the mixture ground to a finely divided state having a relatively large surface area to form the finished cement.

Grinding of the clinker consumes large quantities of energy and time and it is therefore common practice in the industry to use grinding aids. Grinding aids lower the amount of energy and time needed for grinding by increasing the efficiency of the grinding process. The reduced energy consumption can significantly improve the overall cost efficiency of a cement plant, for instance by reducing the operating costs of the plant, increasing cement production throughput, and/or reducing the size of the milling equipment required to grind a given amount of cement.

Previously known grinding aids are lacking for a number of reasons, including that they often require multiple ingredients (>4) many of which do not contribute significantly towards the grinding efficiency improvement.

The problem addressed by this invention is the provision of cement grinding aid compositions that provide improved efficiency during the grinding of cement.

### STATEMENT OF INVENTION

We have now found that the efficiency of cement grinding can be improved by the addition thereto of a grinding aid composition containing a primary or secondary alkanolamine together with a glycol compound. Advantageously, the grinding aid composition minimizes the agglomeration of cement particles as well as their adherence to the surface of grinding media (e.g., steel balls used in a grinding mill) thereby improving the energy and comminution efficiency of the grinding process.

Accordingly, in one aspect, there is provided a grinding aid composition for cement clinker grinding, comprising: an alkanolamine compound that is a primary alkanolamine compound, a secondary alkanolamine compound, or a mixture thereof; and a glycol.

In another aspect, there is provided a cement mix comprising: cement clinker, gypsum, one or more fillers, and a grinding aid composition as described herein.

In a further aspect, there is provided a method for increasing grinding efficiency and/or improving specific surface area of a cement, the method comprising: intergrinding a mix of cement clinker, gypsum, one or more fillers, and a grinding aid composition as described herein.

### DETAILED DESCRIPTION

Unless otherwise indicated, numeric ranges, for instance as in “from 2 to 10,” are inclusive of the numbers defining the range (e.g., 2 and 10).

Unless otherwise indicated, ratios, percentages, parts, and the like are by weight.

As noted above, in one aspect the invention provides a grinding aid composition for cement clinker grinding. The composition advantageously improves the efficiency of a cement grinding process. Such efficiency may be measured, for instance, using Bureau of Indian Standards, IS 4031 (Part 2): 1999 (Reaffirmed 2004), “Methods of physical tests for hydraulic cement: Part 2—Determination of fineness by Blaine air permeability method (Second revision).” This test compares the particle fineness that is achieved in the same amount of time when using a cement mix containing a grinding aid composition of the invention versus a cement mix that does not contain the composition. Thus, as demonstrated by the examples, in some embodiments an improvement in fineness of at least about 2 percent, alternatively at least about 3 percent, or alternatively at least about 4 percent is achieved. In some embodiments, the improvement is about 7.13 percent.

Benefits from the use of a grinding aid may also be measured in terms of the impact of the grinding aid composition on the product performance, such as compressive strength and/or associated properties of cement when used in concrete for construction. In some embodiments, a compressive strength at 28 days of at least 33 MPa, alternatively of at least 39 MPa is achieved with the compositions of the invention. The compressive strength is measured as per Bureau of Indian Standards, IS 4031 (Part 6): 1988 (Reaffirmed 2005), “Methods of physical tests for hydraulic cement: Part 6—Determination of compressive strength of hydraulic cement other than masonry cement (First revision)”.

Improvement through use of a cement grinding aid composition may also be measured in terms of reduced energy consumption to achieve equivalent fineness in a cement mix, during the grinding process, when compared to a control sample. For instance, in some embodiments, energy consumption with the invention at a 5 kg scale may be 0.5 kWh/batch or less, alternatively 0.35 kWh/batch or less.

The grinding aid composition of the invention comprises: an alkanolamine compound that is a primary alkanolamine compound, a secondary alkanolamine compound, or a mixture thereof; and a glycol.

Suitable primary alkanolamine compounds include, for instance, an amine compound containing a C₂-C₈ hydroxy alkyl group, preferably a C₂-C₄ hydroxylalkyl group. In some embodiments, the primary alkanolamine compound is monoethanolamine, monoisopropanolamine, monobutanolamine (n, iso, or tert, with iso being preferred), or mixtures thereof. A preferred primary alkanolamine is monoisopropanolamine (MIPA).

Suitable secondary alkanolamine compounds include, for instance, an amine compound containing at least one, preferably two (independently selected), C₂-C₈ hydroxy alkyl groups. In some embodiments, the secondary alkanolamine compound is an amine containing two independently selected C₂-C₄ hydroxylalkyl groups. In some embodiments, the secondary alkanolamine compound is diethanolamine, diisopropanolamine, diisobutanolamine, or mixtures thereof. A preferred secondary alkanolamine is diethanolamine (DEA).

In some embodiments, the grinding aid composition contains at least 40 weight percent, alternatively at least 50 weight percent, or alternatively at least 60 weight percent of the alkanolamines (both the primary and secondary alkanolamine) based on the total weight of the grinding aid composition. In some embodiments, the grinding aid composition contains 70 weight percent or less of the alkanolamines.

Suitable glycols for use in the invention include, for examples, polyalkylene glycols such as compounds of the formula: HO—(CH₂CH(R)—O)ₙ—H, wherein R is H or methyl and n is an integer from 1 to 10, preferably 1 to 5. In some embodiments, the glycol compound is monoethylene glycol, diethylene glycol, triethylene glycol, polyethylene glycol, monopropylene glycol, dipropylene glycol, tripropylene glycol or a mixture thereof. Preferred glycol compounds include monoethylene glycol (MEG), propylene glycol (PG), or mixtures thereof.

In some embodiments, the grinding aid composition contains at least 25 weight percent, alternatively at least 35 weight percent, or alternatively at least 40 weight percent of the glycol based on the total weight of the grinding aid composition. In some embodiments, the grinding aid composition contains 50 weight percent or less of the glycol.

In some embodiments, the weight ratio of all alkanolamines in the composition to the glycol is from 3:1 to 1:1. In a preferred embodiment, the weight ratio is 1:1.

In a preferred embodiment, the grinding aid composition contains diethanolamine and a glycol compound that is monoethylene glycol, propylene glycol, or a mixture thereof. In a further preferred embodiment, the grinding aid composition contains diethanolamine and a glycol compound that is monoethylene glycol, propylene glycol, or a mixture thereof, and the weight ratio of the diethanolamine to the glycol is from 3:1 to 1:1, preferably it is 1:1.

The grinding aid composition of the invention may, in some embodiments, contain water as an additional additive. When present, the water may comprise at greater than 0 weight percent, alternatively at least 15 weight percent, or alternatively at least 30 weight percent, based on the total weight of the grinding aid composition. In some embodiments, the grinding aid composition contains 55 weight percent or less of water.

The grinding aid composition of the invention may be incorporated in various types of cement mixes, including hydraulic cements, for example Portland cement or Pozzolona Portland cement. A cement mix according to the invention comprises: the grinding aid composition as described above, cement clinker, gypsum, and optionally one or more fillers such as fly-ash, bagasse-ash, fumed silica, limestone, construction debris, etc.

The amount of grinding aid composition (including optional ingredients such as fillers and water) in the cement mix is, in some embodiments, at least 0.01 weight percent, alternatively at least 0.05 weight percent, based on the total weight of the cement mix. In some embodiments, the amount of grinding aid composition in the cement mix is 0.1 weight percent or less.

One of the advantages of the invention is that it provides increased cement grinding efficiency to a cement mix without the need for other, more complex or more expensive grinding aids. Thus, in some embodiments, the cement mix is substantially free of one more of the following grinding aid materials: tertiaryalkanolamines, lignins, glycerols, hydroxylamines (other than the primary and secondary alkanolamines contemplated by this invention), diamines, particulate carbon, lignosulphonic acids, or salts of aliphatic acids. By “substantially free” is meant that the cement mix contains 0.1 weight percent or less, alternatively 0.05 weight percent or less, or alternatively 0.01 weight percent or less, or alternatively 0 percent of each component, based on the total weight of the cement mix.

The cement clinker, gypsum, and optional fillers (such as fly ash) are typical ingredients of cement mixes that are well known in the art. For instance, Portland cement clinker is a hydraulic material comprised of calcium silicates and aluminates/aluminoferrites produced by calcination of limestone and clay in the kiln. Thus the clinker may contain, for example, oxides of calcium, silicon, aluminum, and iron (III). In some embodiments, the cement clinker comprises calcium oxide (CaO), silicon dioxide (SiO2), iron oxide (Fe2O3), aluminum oxide (Al2O3), sulfite (SO3-) and free lime. In some embodiments, the amounts of each of the foregoing components in the clinker is as follows: from 61 to 67 weight percent of CaO, from 19 to 23 weight percent of SiO₂, from 0 to 6 weight percent of Fe₂O₃, from 2.5 to 6 weight percent of Al₂O₃, from 0.5 to 4.5 weight percent of SO₃—, and from 0.5 to 1.5 weight percent of free lime. Alternately, this can be expressed in terms of the mineralogical phase composition of the clinker as follows: 55 to 65 weight percent of C₃S (alite, tricalcium silicate), 10 to 20 weight percent of C₂S (belite, dicalcium silicate), 5 to 15 weight percent of C₃A (Tricalcium aluminate), 5 to 15 weight percent C₄AF (tetracalcium aluminferrite) and 0 to 10 weight percent other phases (such as periclase, quartz).

Industrial scale grinding typically involves a pre-sized (crushed) feed of clinker and gypsum (the order of fly ash mixing varies, pre-mixing or post-mixing) entering a continuous ball mill with multiple internal sections separated by screens (classification). The grinding aid may be sprayed inside the ball mill or just before the mill through a continuous dosing circuit. The outlet stream from the mill goes to a cyclone separator where the in-spec product is withdrawn and the out-of-spec product may be recycled back to the mill. The feed/recycle rates and the residence time may be controlled based on the outlet stream properties.

Some embodiments of the invention will now be described in detail in the following Examples.

### EXAMPLES

Grinding trials are conducted in a lab-scale ball mill with feed material containing cement clinker, gypsum (equivalent to 1.9-2.3% SO3 content) and fly ash (25% content) to generate samples of Pozzolona Portland Cement (PPC), and grinding media (steel balls) to a feed ratio of 6:1. At a grinding batch size of 5 kg of total feed material, these trials are carried out: (i) without any additive (control sample, no CGA) and (ii) with different formulations based on alkanolamine-glycol-water blends added at a dosage of 200 ppm. The PPC product samples are analyzed for their specific surface area as per Bureau of Indian Standards, IS 4031 (Part 2): 1999 (Reaffirmed 2004), “Methods of physical tests for hydraulic cement: Part 2—Determination of fineness by Blaine air permeability method (Second revision).”

The grinding time required to achieve a product fineness of 3500 cm2/g (Blaine value) in a control batch is first established (52 min) and the grinding trials with the different formulations are conducted for the same time. The resultant product samples are analyzed for their Blaine fineness and the grinding efficiency of the formulations is evaluated in terms of the improvement over the control sample.

The following table shows the composition and grinding performance for some of the representative formulation examples that were evaluated:

| | | | Composition of formulation | | | | |
|---|---|---|---|---|---|---|---|
| | | | (proportion of component in mixture) | | | | |
| | | % | | Mono- | Mono- | | |
| | Blaine | Improvement | Diethanol- | isopropanol- | ethylene | Propylene | |
| Formulation | value | (over | amine | amine | glycol | glycol | Water |
| ID | (cm2/g) | control) | (DEA) | (MIPA) | (MEG) | (PG) | (H2O) |
| Control | 3519 | 0.0% | — | — | — | — | — |
| (No CGA) | | | | | | | |
| CGA#10 | 3770 | 7.13% | 0.5 | 0 | 0 | 0.5 | 0 |
| CGA#13 | 3680 | 4.58% | 0.5 | 0 | 0.5 | 0 | 0 |
| CGA#35 | 3670 | 4.29% | 0.33 | 0.33 | 0 | 0.33 | 0 |
| CGA#11 | 3660 | 4.01% | 0.25 | 0.25 | 0.25 | 0 | 0.25 |
| CGA#37 | 3650 | 3.72% | 0.25 | 0.5 | 0 | 0.25 | 0 |
| CGA#14 | 3640 | 3.44% | 0.25 | 0.25 | 0 | 0.25 | 0.25 |

The above formulations show improved performance as compared to the alkanolamine only and the glycol only type blends of these components as shown below:

| | | | Composition of formulation | | | | |
|---|---|---|---|---|---|---|---|
| | | | (proportion of component in mixture) | | | | |
| | | | | Mono- | Mono- | | |
| | Blaine | % | Diethanol- | isopropanol- | ethylene | Propylene | |
| Formulation | value | Improvement | amine | amine | glycol | glycol | Water |
| ID | (cm2/g) | (over control) | (DEA) | (M IPA) | (MEG) | (PG) | (H2O) |
| Control | 3519 | 0.0% | — | — | — | — | — |
| (No CGA) | | | | | | | |
| CGA#02 | 3629 | 3.13% | 0 | 0 | 0.5 | 0.5 | 0 |
| CGA#20 | 3600 | 2.30% | 0.55 | 0.45 | 0 | 0 | 0 |

Additionally, in these trials, a blended formulation (27:73) of triethanolamine (TEA) and triisopropanolamine (TIPA) which are two of the most extensively reported chemicals as cement grinding aids in prior art, gave a Blaine value of 3625 cm2/g (3.01% improvement over control), i.e. all the new alkanolamine-glycol blend formulations evaluated in these trials provide better performance than the reference formulation.

1. A grinding aid composition for cement clinker grinding, comprising: an alkanolamine compound that is a primary alkanolamine compound, a secondary alkanolamine compound, or a mixture thereof; and a glycol.

2. The grinding aid composition of claim 1 wherein the primary alkanolamine compound comprises one C₂-C₈ hydroxyalkyl group.

3. The grinding aid composition of claim 1 wherein the primary alkanolamine compound is selected from monoethanolamine, monoisopropanolamine, monobutanolamine, and mixtures thereof.

4. The grinding aid composition of claim 1 wherein the secondary alkanolamine compound comprises at least one C₂-C₈ hydroxyalkyl group.

5. The grinding aid composition of claim 1 wherein the secondary alkanolamine compound is selected from diethanolamine, diisopropanolamine, diisobutanolamine, and mixtures thereof.

6. The grinding aid composition of claim 1 wherein the glycol comprises a polyakylene glycol such as monoethylene glycol, diethylene glycol, triethylene glycol, polyethylene glycol, monopropylene glycol, dipropylene glycol, tripropylene glycol or a mixture thereof.

7. The grinding aid composition of claim 1 further comprising water.

8. The grinding aid composition of claim 1 comprising from 40% to 70% of the alkanolamine compound, from 25% to 50% of the glycol, and from 0% to 55% of water, each by weight based on the total weight of the grinding aid composition.

9. A cement mix comprising: cement clinker, gypsum, and the grinding aid composition of claim 1.

10. The cement mix of claim 9 comprising from 60% to 90% of the cement clinker, from 3.0% to 10.0% of the gypsum, from 0% to 36% of one or more fillers, and from 0.01% to 0.1% of the grinding aid composition, each by weight based on the total weight of the cement mix.

11. The cement mix of claim 9 wherein the cement clinker comprises from 61 to 67 weight percent of CaO, from 19 to 23 weight percent of SiO₂, from 0 to 6 weight percent of Fe₂O₃, from 2.5 to 6 weight percent of Al₂O₃, from 0.5 to 4.5 weight percent of SO₃—, and from 0.5 to 1.5 weight percent of free lime.

12. The cement mix of claim 9 wherein the cement clinker comprises 55 to 65 weight percent of C₃S (alite, tricalcium silicate), 10 to 20 weight percent of C₂S (belite, dicalcium silicate), 5 to 15 weight percent of C₃A (tricalcium aluminate), 5 to 15 weight percent C₄AF (tetracalcium aluminoferrite) and 0 to 10 weight percent other phases.

13. The cement mix of claim 9 having a 28 day compressive strength of at least 33 MPa.

14. A method for increasing grinding efficiency and improving specific surface area of a cement, the method comprising: intergrinding a mix of cement clinker, gypsum, one or more fillers, and the grinding aid composition of claim 1.
